(19) United States
(12) Patent Application Publication
(10) Pub. No.: US 2014/0089403 A1
(43) Pub. Date: Mar. 27, 2014

(54) System and Method for Qualifying and Targeting Communications using Social Relationships

(71) Applicants: Alexander P. Gross, Portland, OR (US); Jacob M. Blakely, Albany, OR (US)

(72) Inventors: Alexander P. Gross, Portland, OR (US); Jacob M. Blakely, Albany, OR (US)

(21) Appl. No.: 13/628,440

(22) Filed: Sep. 27, 2012

(51) Int. Cl. G06F 15/16

(52) U.S. Cl. 709/204

(57) ABSTRACT

A system to filter and target media takes advantage of users' desire to converse and share with friends to provide both more-accurate selection of media to present to the friends, and increased influence of the selected messages because of the selection process. The system can be used to help social relationships.

### CONTINUITY AND CLAIM OF PRIORITY

This is an original U.S. patent application.

### FIELD

The invention relates to automated electrical, financial or business practice or management arrangement. More specifically, the invention relates to improving advertising effectiveness by leveraging social relationships to target ads based on user profiles or attributes.

### BACKGROUND

The Internet has brought vast quantities of information within easy reach—so much, and so easy, in fact, that the problem of finding something of interest (the proverbial needle in the haystack) has become a problem of finding the right needle in a haystack-sized pile of needles. Algorithmic and statistical search engines have made great strides in improving this situation, but the gains are relentlessly whittled down by those with a pecuniary interest in having certain items appear in search results, regardless of the value of those items to the searcher.

In this war of one-upmanship between search engine operators and search-engine optimizers (“SEO”), end users and advertisers suffer collateral damage when they cannot connect effectively. (Here, “advertisers” is used in the broader sense of “a party who has material that might be of interest to the searcher;” but the searcher does not find it because search-engine-optimized material—often spurious or duplicative—has successfully gamed the search algorithm to appear near the top of a result set.)

Beyond the problem of SEO spam and content farming (producing or republishing cheap, low-quality material for the primary purpose of attracting web traffic from inattentive or undiscriminating viewers), legitimate advertisers face the more mundane problem reaching their target audiences efficiently, without wasting resources to connect with people who are unlikely to be interested.

New methods for improving the “hit ratio” of good, desired, and beneficial communications between advertisers and searchers may be of significant value.

### SUMMARY

Embodiments of the invention leverage users' social relationships to help filter and target communications to the viewers who will be most interested in them. Users' natural desire to connect, converse and share with friends is incorporated into a system to improve the participants' signal-to-noise ratio.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample environment where an embodiment of the invention may be operated.

FIG. 2 shows how an embodiment can select, qualify and send Warm-Ups.

FIG. 3 presents some details of a process for sending a user-selected Warm-Up.

FIG. 4 is a flow chart of operations according to another embodiment of the invention.

FIG. 5 shows additional operations that may occur in connection with an embodiment.

### DETAILED DESCRIPTION

Embodiments of the invention may be understood generally as a part of the social-media ecosystem, where they promote and support relationships between users. The relationships are generally stronger than mere acquaintance; embodiments are most effective when the participants interact regularly (whether they do so mostly through electronic communications or they often meet in real life).

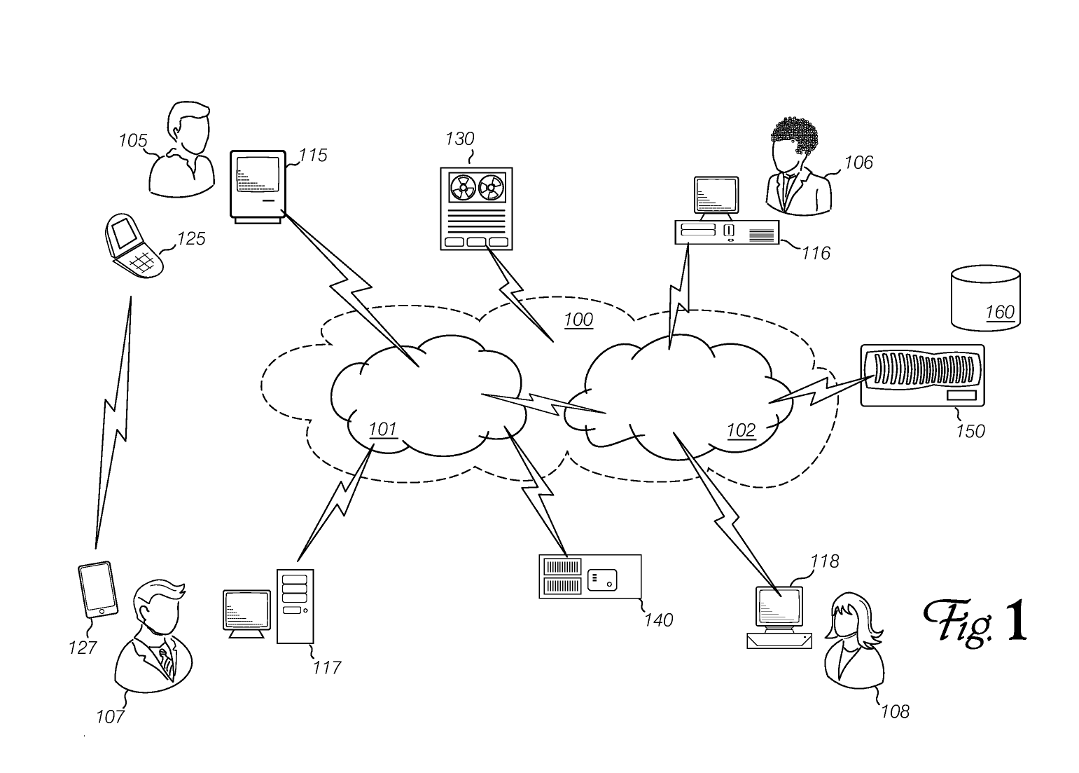

FIG. 1 shows an environment where an embodiment of the invention can be deployed. A wide variety of users and devices may participate in the embodiment, but usually, most interactions between participants will occur via communications carried by a distributed data network (a “network 100 of networks 101, 102” such as the Internet). Users 105-108, who may be physically located anywhere around the world, use their various computing devices 115-118, respectively, to communicate directly (e.g., via real-time text or video chat), through an email server 130, with an interactive web site 140, or through other online facilities. (Some users may also interact through other devices and channels. For example, users 105 and 107 may communicate via cell phones 125, 125 by voice or Small Messaging Service (“SMS”) text message).

An embodiment operates through coordinated actions that may be performed by different devices participating in this distributed communication and computing environment. For simplicity of explanation and concreteness, the following outlines and flow charts may specify that an action occurs somewhere, or that a particular device performs a certain task, but it should be understood that most embodiment tasks can be performed anywhere that the required data, computing and communication capability can be brought together.

One useful way of thinking about embodiments of the invention is that they form a digital curation system, to find, select and deliver useful content to the viewers most likely to appreciate it. Additionally, embodiments operate to place the content within the context of an ongoing conversation between friends, so it becomes an integral part of their relationship, enhancing conversations and supporting the relationship.

Note that all embodiments use a library or database of collected media items, so we will assume that such a library has been constructed and is maintained on an ongoing basis, for example by using existing web-spidering techniques, monitoring newsfeeds and RSS feeds, and “following” other social-media trends. Items in the library may be, for example, web pages, video clips, MP3 (music) files, magazine articles, and other electronically-accessible information. The library may also contain scheduling information for performances, sporting events and so on. Digital information may be stored directly in the database, or links to information stored elsewhere may be placed there. Conventional text analysis and natural-language processing techniques are used to tag media items with information about their subjects, relevant dates, and other criteria to be used in an embodiment as described below. Some systems will accept media items submitted from third parties, such as advertisers. Submitted items may be pre-tagged with topics that the advertiser believes will be relevant.

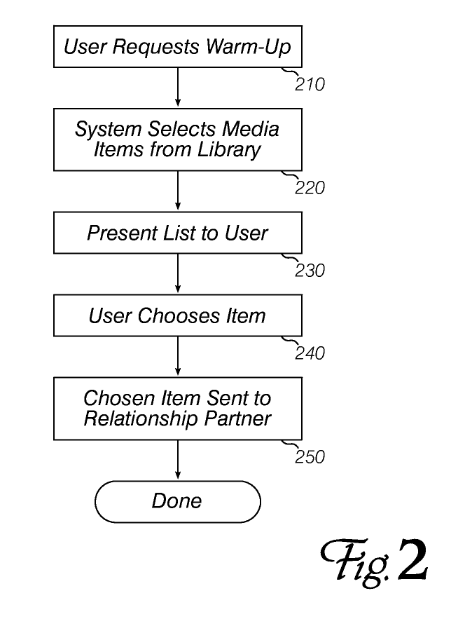

FIG. 2 outlines core events and interactions that happen during operation of an embodiment. First, a user of the system (we'll call him “Jack”), in the context of an ongoing conversation, or to reconnect and start a new conversation after a period of separation, decides that he would like to share a media item with a friend (“Jill”).

Jack sends a request to the system to obtain a media item of relevance to Jill and/or Jack and Jill's relationship (210). Information to allow the system to select such items has been previously configured; techniques for doing so are discussed later. The system uses information about Jack, Jill and their relationship to select several media items from the library (220), and presents a list of the selected items to Jack (230). (The inventors sometimes refer to items in this list as “Warm-Ups.”) Jack may choose one of the items (240), and the system will facilitate sending the item to Jill (250). (In some embodiments, the system will send the item directly, by electronic mail, SMS message, or other communication facility judged reasonably likely to reach Jill; while in others, Jack will be offered a range of possible options for sending the Warm-Up to Jill).

Several points should be noted about this process. First, Jack requests, and is presented with, a menu of Warm-Ups for Jill, that is, selected on the basis of Jill's interests and/or relevance to the Jack-Jill relationship, not items for Jack himself. (An embodiment may offer selections that are of no particular interest to Jack, apart from their possible interest to Jill, or relevance to the relationship.) Second, Jack is doing more than passively selecting an item from a list of items chosen by algorithm for relevance to Jill. He is providing a final, expert filtering decision, choosing an item from the sort of list that might be presented to Jill if she searched for something for herself. Jack's choice, made with knowledge of Jill's interests and preferences, as well as the history of their relationship, is likely to be more valuable to Jill because Jack chose it. And relatedly, Jill is more likely to read (view, listen, etc.) to the choice because the embodiment has helped Jack position the Warm-Up within the relationship and ongoing conversation.

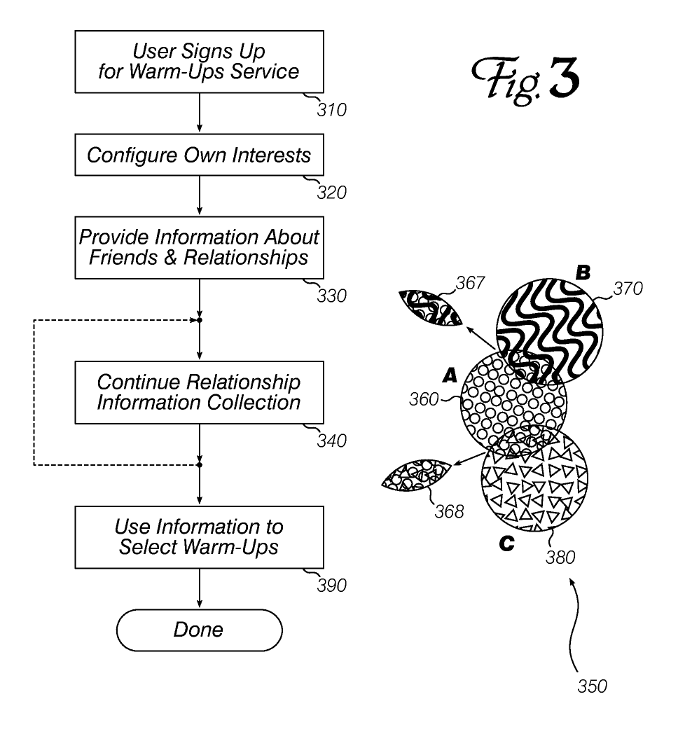

How is an embodiment able to choose items from its library to present to a user in response to the user's request for a Warm-Up? As outlined in FIG. 3, a user begins his interactions with an embodiment by signing up for the service (310), perhaps providing his name, email address, telephone number, address, or other information, and selecting a username and password. Next, he provides information about his own interests (320), and names and information about friends with whom he would like to use the service (330). All of this information (personal and about friends) may be collected via guided questionnaires, or the new user may allow a software agent of an embodiment to scan through his email and other social-media archives to collect the information.

In most embodiments, collection of information about the participants and their relationships is an ongoing process (340), much like the collection of media items for the library or database. For example, an enrolled user may allow a software agent of the embodiment to continuously monitor his email conversations, blog posts and social-media interactions. Some embodiments may provide phone “apps” to monitor voice calls, SMS messages and the like. (Voice call monitoring may be limited to the time, date and identity of callers and callees, or the actual conversation may be processed as well.) Many contemporary phones have geolocation capabilities (e.g., GPS), so an embodiment may collect information about where the user has gone, and when; to detect when the user may have met with one of his friends (e.g., at a store, concert or elsewhere).

As a result of initial relationship configuration and ongoing monitoring, the system is able to build and maintain sets of topics of interest to the various parties, as suggested by the Venn diagrams at 350. Each participant has a set of topics of interest (360, 370, 380) that is known to the embodiment, and sets are likely to intersect between pairs of users (367, 368). (Embodiments of the invention focus principally on conversations and relationships between pairs of users, rather than on a single topic that is of interest to a larger group of people.)

Topics of interest and/or relevance to the various configured relationships can be maintained with input from only one party to the relationship (e.g., user A alone can provide information to construct sets 370 and 380), but an embodiment can offer improved performance and more accurate media selections if the other parties to the relationships (B and C) are also enrolled, and also use software agents to submit information about their conversations and relationships. The collected information is used as outlined in FIG. 2 to select media items for a Warm-Ups list (390), for requesting user A to send to his friend B.

In some embodiments, a user can configure a new relationship by directing the system to retrieve information about the other person. For example, the user may provide account names for the other person on social media sites like Facebook and LinkedIn, and the embodiment will download public information from those sources to populate the initial set of topics for that person.

An embodiment may allow the user to set up groups of people who have a similar relationship to the user. For example, a user may set up a “Family” group containing siblings and cousins. Then, instead of requesting a Warm-Up for one individual, the user may request a Warm-Up for “Family,” and receive a list of media items, one of which may be chosen to be sent to the brothers, sisters and cousins.

The basic topic-set maintenance and media-item selection functions of an embodiment can be incorporated into a larger system designed to support users' social relationships. In particular, this larger system may be useful for helping users keep long-distance or “virtual” relationships active. (“Virtual” relationships are between people who rarely or never meet. They may develop between people who kept in touch after moving apart, or between people who “met” online through a website or multiplayer game.) Such relationships can go dormant because the parties never encounter one another, except through the game, website, or when one happens to call or email the other.

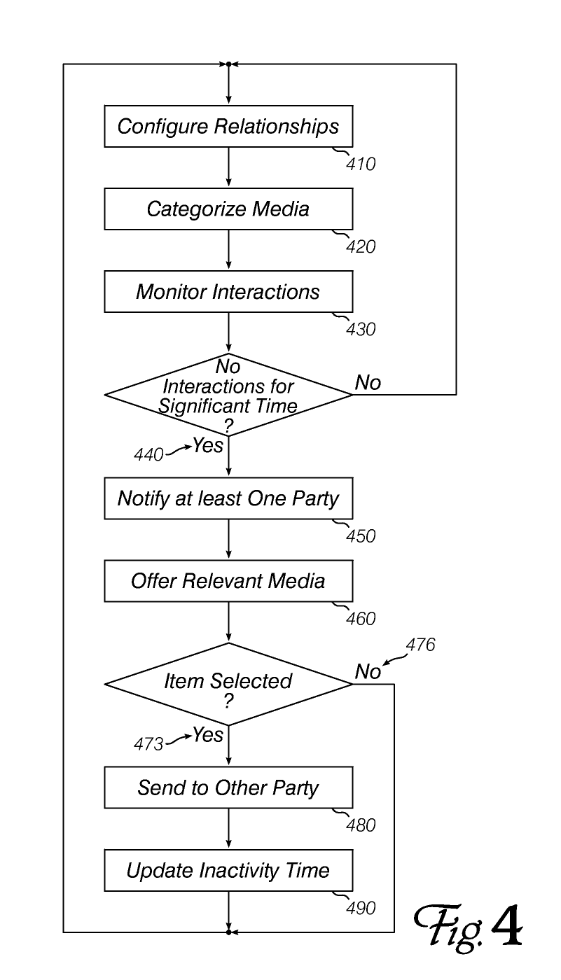

An embodiment of the invention can use the communication-monitoring software agents mentioned above to implement the process outlined in FIG. 4. As in other embodiments, the user configures relationships that he wishes to use the system to support (410), and the system collects and categorizes media items into a library (420). The system also monitors interactions between the user and the other party of the configured relationships (430).

If no interactions are observed between the user and one of his friends for a significant period of time (440) then the user (and possibly the other party) will be notified (450). The offer may include a “Warm Up” list of relevant media (460). Recall that the Warm-Up list offered to one party to the relationship, is comprised of items of interest to the other party. If the party receiving the Warm-Up list selects an item (473), then the system arranges to send it to the other party (480), and the inactivity timer is updated (490). The notified party may decide not to send one of the Warm-Ups (476), so the system may notify him of the inactive relationship again later.

From another perspective, Warm-Ups are a system for recommending content to two distinct individuals based on their shared interests, characteristics and relationship—they target both individuals simultaneously. This is different from (and more powerful than) “self-targeted” searching and advertising, where one searches for one's own media items, and receives results and associated advertising directed at oneself, selected statistically by a computer. Embodiments of the invention improve both selection quality and influence with the recipient by adding the “filtering” action of the sending individual, who has personal knowledge of the intended recipient.

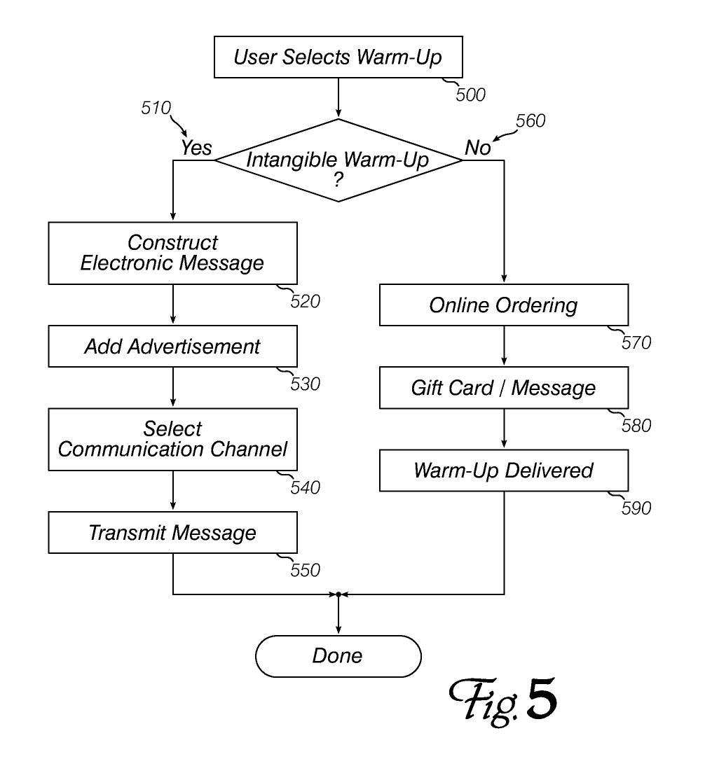

Turning to FIG. 5, we consider activities that may be performed by an embodiment after the user selects a Warm-Up from the list or menu presented (500). The Warm-Up may be an intangible item that can be transmitted electronically, such as a web page or a video. If so (510), the embodiment may construct an electronic message containing or linking to the selected Warm-Up (520). This message may be augmented with an advertisement or similar addendum that is related to the Warm-Up content (530). For example, if the Warm-Up is a movie trailer, the system may attach a coupon for discounted admission to the movie. Finally, the user may be offered a selection of communication channels through which to send the message (e.g., email, SMS text message or tweet) (540), and the message is transmitted to the recipient (550).

In some embodiments, the Warm-Ups list may include information about physical objects. The information (e.g., an article or product review, photograph, or notice of special offer) may be intangible and electronically transmittable, but an embodiment may allow the user to purchase (or otherwise obtain) the Warm-Up itself and have it sent to his friend. Thus, if the Warm-Up is tangible (560), the embodiment may perform a conventional online-ordering process (570) to arrange for shipping and payment. The process may include the selection of a gift card or specification of a message from the sender (580), and the Warm-Up will be delivered to the user's friend in due course (590).

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that a system can provide services to support social relationships via software and hardware that distribute the functions of embodiments of this invention differently than herein described. Such variations and implementations are understood to be captured according to the following claims.

We claim:

1. A method for qualifying shared content in a two-party relationship between individuals A and B, the method comprising:
maintaining a set of topics of interest to B;
categorizing a plurality of media items according to their estimated relevance to the set of topics;
receiving a request from A for a media item of relevance to an A-B relationship;
selecting a subset of the plurality of media items with a high estimated relevance to the set of topics; and
displaying the subset of the plurality of media items to A.

2. The method of claim 1, further comprising:
receiving a choice from A of one of the media items of the subset of the plurality of media items; and
sending the chosen media item to B.

3. The method of claim 1, further comprising:
maintaining a second set of topics of interest to A.

4. The method of claim 3, further comprising:
receiving a request from B for a media item of relevance to the A-B relationship;
selecting a second subset of the plurality of media items with a high estimated relevance to the second set of topics; and
displaying the second subset of the plurality of media items to B.

5. The method of claim 4, further comprising:
receiving a second choice from B of one of the media items of the second subset; and
sending the second chosen media item to A.

6. The method of claim 1 wherein the plurality of media items includes a web page, a blog post, a still image, a video, a music file and a news article.

7. The method of claim 2 wherein the plurality of media items includes information about a tangible object, the method further comprising:
if the chosen media item is information about a tangible object, then
performing an online-ordering process with A to cause the tangible object to be delivered to B.

8. The method of claim 2 wherein the plurality of media items includes information about a movie, the method further comprising:
if the chosen media item is information about a movie, then
adding a coupon for a discount ticket to the movie to the chosen media item before sending the chosen media item to B.

9. The method of claim 1, further comprising:
accepting an item from an advertiser; and
adding the item to the plurality of media items.

10. The method of claim 9, wherein the item comprises a tag to indicate a topic to which the item is relevant.

11. A method for qualifying shared content in a two-party relationship between individuals A and B, the method comprising:
maintaining first and second sets of topics of interest to A and B, respectively;
categorizing a plurality of media items according to their estimated relevance to the topics in the first and second sets of topics;
receiving a request from A for a Warm-Up of relevance to an A-B relationship;
presenting a menu of potential Warm-Ups selected from the plurality of media items based on their estimated relevance to topics in the second set of topics;
accepting a selection of a Warm-Up from the menu of potential Warm-Ups; and
sending the selected Warm-Up to A.

12. The method of claim 11, further comprising:
monitoring a communication channel from A to B; and
updating the first and second sets of topics according to messages observed in the communication channel.

13. The method of claim 11, further comprising:
monitoring a communication channel from B to A; and
updating the first and second sets of topics according to messages observed in the communication channel.

14. The method of claim 11 wherein the plurality of media items includes scheduling information for a sporting event.

15. The method of claim 11 wherein the plurality of media items includes scheduling information for a concert.

16. A computer-readable medium containing data and instructions to cause a programmable processor to perform the method of claim 1.
